(19) United States
(12) Patent Application Publication
(10) Pub. No.: US 2024/0157285 A1
(43) Pub. Date: May 16, 2024

(54) Carbon Capture System with Temperature Controlled Absorber Bottom

(71) Applicant: University of Kentucky Research Foundation, Lexington, KY (US)

(72) Inventors: Kunlei Liu, Lexington, KY (US); Heather Nikolic, Stamping Ground, KY (US); Reynolds Frimpong, Lexington, KY (US); Fan Zhen, Parsippany, NJ (US); Chin Ng, Lexington, KY (US)

(21) Appl. No.: 18/389,398

(22) Filed: Nov. 14, 2023

Related U.S. Application Data
(60) Provisional application No. 63/425,266, filed on Nov. 14, 2022.

(51) Int. Cl. B01D 53/14; B01D 53/18; B01D 53/34; B01D 53/62; B01D 53/78; B01D 53/96

(52) U.S. Cl. CPC B01D 53/1412; B01D 53/1425; B01D 53/1475; B01D 53/185; B01D 53/346; B01D 53/62; B01D 53/78; B01D 53/96; B01D 2252/204; B01D 2257/504

(57) ABSTRACT

A system and method are provided for capturing carbon dioxide from a flue gas. The system includes an absorber, a stripper, a cooling system and a control module. The cooling system is adapted to independently cool (a) a flue gas upstream from an absorber flue gas inlet and (b) a carbon dioxide-lean carbon capture solution being delivered to each of a plurality of lean carbon capture solution inlets at the different levels of the absorber. The control module includes a controller and a plurality of temperature sensors. The controller is responsive to the plurality of temperature sensors provided at each of the different levels of the absorber to control operation of the cooling system and thereby maintain a desired temperature profile at the different levels of the absorber to enhance rich loading of carbon dioxide from the flue gas to a carbon capture solution and reduce energy requirements for lean carbon capture solution regeneration in the stripper.

### RELATED APPLICATION

This application claims priority to U.S. Provisional Patent Application Ser. No. 63/425,266 filed on Nov. 14, 2022, which is hereby incorporated by reference in its entirety.

### TECHNICAL FIELD

This document relates generally to a new and improved system and method for the capture of carbon dioxide (CO₂) from a gas stream.

### BACKGROUND

The cleanup of acid gasses, such as CO₂, from natural gas, other carbon-based feedstock combustion, and other point sources has been an extensively practiced technology. The industrial removal of CO₂ from flue gases dates back to the 1930's. While several technologies exist for the removal of acid gasses, one of the most employed practices is the use of aqueous amines. In this process the amine reacts with the CO₂ to form a carbamate, carbonate or bicarbonate salt along with a protonated amine to balance the overall charge. In this prior art thermal swing absorption process illustrated in FIG. 1, the liquid, CO₂ rich amine from the bottom of the absorber A, is passed through a heat exchanger B to recover energy before being heated to a higher temperature in the stripper C. The stripper C liberates the CO₂ as a gas from the amine solution to produce a lean, or CO₂ deficient solution. The lean solution is returned to the absorber A by way of the heat exchanger B to repeat the process.

The application of CO₂ capture to low CO₂ concentration point sources (0.5-10 vol %), such as natural gas combined cycle (NGCC) flue gas separation has recently been an area of major interest. Due to the maturity of aqueous amine carbon capture systems, this technology will remain the preferred method when new regulations require widespread full-scale deployment of post-combustion CCS for reducing emissions from carbon-based feedstock combustion.

This CO₂ capture technology, which boosts the rich solvent carbon loading at the absorber bottom, is also especially applicable to other low CO₂ concentration flue gases, such as the steel and alumina processing industries, food industries where a low CO₂ concentration naturally results in a lower rich solvent carbon loading at the absorber bottom.

In the shorter-term, using captured CO₂ for Enhanced Oil Recovery (EOR) and utilization in downstream products (polymers or chemicals) is a significant opportunity for marketing technical solutions. The total market for post-combustion CO₂ capture technologies (>$6B over the next 20 years) represents massive potential value for intellectual property development sales such as from technology development or licensing fees.

With continued societal and regulatory concern over the global climate change, the market has been driving the post-combustion capture technology development towards commercial scale. However, there is still a need for significant technological advancements and cost reduction strategies to make these systems cost-competitive.

In a conventional CO₂ absorber A, shown in FIG. 1, the lean carbon capture solution travels through the absorber from the top to the bottom by forming a film on structured packing. The flue gas travels up, counter-current to the lean solution, through the void spaces of the packing and CO₂ is transferred by an exothermal chemical reaction to the liquid phase at the liquid-gas interface. The CO₂ absorption chemical reaction kinetics and diffusion of the CO₂ through both the liquid-gas interface and into the bulk liquid phase affect the overall CO₂ mass transfer.

This document relates to a new and improved CO₂ capture system utilizing a lower temperature at the bottom of the absorber packing, which might be achieved by a lowered temperature of flue gas fed to the bottom of the absorber and/or lowered solvent temperature at controlled feed locations and/or in-situ bottom chilling to enhance rich carbon loading of solvents and thereby minimize the specific reboiler duty during regeneration in the stripper when applied to flue gas stream with CO₂ concentration less than 10 vol % such as natural gas combined cycle (NGCC) or other point source flue gas such as natural gas boiler, steel/aluminum, cement and food processing. Operation with the absorber bottom temperature below what is naturally achieved by the lean rich exchanger and cooling water allows for increased rich loading according to the solvent vapor-liquid equilibrium relationship and mass transfer driving force. This higher rich loading leads to a reduced energy requirement for lean solvent regeneration.

### SUMMARY

In accordance with the purposes and benefits set forth herein, a new and improved carbon capture system is provided. That carbon capture system comprises, consists of or consists essentially of: (a) an absorber having a plurality of lean carbon capture solution inlets at different levels of the absorber, a rich carbon capture solution outlet, and a flue gas inlet, (b) a stripper having at least one rich carbon capture solution inlet connected to the rich carbon capture solution outlet and a lean carbon capture solution outlet connected to the plurality of lean carbon capture solution inlets, (c) a cooling system adapted to independently cool a flue gas upstream from the flue gas inlet and a carbon dioxide-lean carbon capture solution being delivered to each of the plurality of lean carbon capture solution inlets at the different levels of the absorber, and (d) a control module including a controller and a plurality of temperature sensors wherein the controller is responsive to the plurality of temperature sensors provided at each of the different levels of the absorber to control operation of the cooling system and thereby maintain a desired temperature profile at the different levels of the absorber packing to enhance loading of carbon dioxide from the flue gas to a carbon capture rich solution and reduce energy requirements for lean carbon capture solution regeneration in the stripper.

In at least one of the many possible embodiments of the carbon capture system, the controller is adapted to maintain a carbon dioxide rich-carbon capture solution in a bottom section of the absorber at a predetermined temperature of less than or equal to 45° C. In other possible embodiments, the controller is adapted to maintain the carbon dioxide rich-carbon capture solution in the bottom section of the absorber at a predetermined temperature of less than or equal to 35° C.

The cooler may include a direct contact cooler upstream from the flue gas inlet that is adapted to cool the flue gas to a predetermined temperature prior to delivery to the absorber and the control module further includes a flue gas temperature sensor for monitoring current temperature of the flue gas exiting the direct contact cooler. The direct contact cooler may include (a) a cooling chamber having a flue gas inlet, a cooling water inlet, and a water recycling outlet, (b) a cooling water pump connected to a cooling/chilled water source and (c) a recycling pump adapted for returning water from the direct contact cooler to the cooling water source. Still further, the direct contact cooler may include at least one cooling water sprayer in the cooling chamber that receives cooling/chilled water from the cooling water pump.

In some embodiments of the carbon capture system, the cooler further includes a chiller in a carbon dioxide rich-carbon capture solution recycling circuit adapted for recycling a portion of the carbon dioxide rich-carbon capture solution to the bottom section of the absorber. The cooling system may include a separate and independently controller-controlled chiller upstream from each of the plurality of lean carbon capture solution inlets.

In accordance with yet another aspect, a method of capturing carbon dioxide from a flue gas, comprises, consists of or consists essentially of the steps of: (a) capturing the carbon dioxide with a carbon dioxide-lean carbon capture solution in an absorber to generate a carbon dioxide-rich carbon capture solution, (b) regenerating the carbon dioxide-lean carbon capture solution from the carbon dioxide-rich carbon capture solution in a stripper, and (c) maintaining the carbon dioxide-rich carbon capture solution in a bottom section of the absorber at a temperature at or below 45° C. In some embodiments, the method includes maintaining the carbon dioxide-rich carbon capture solution in a bottom section of the absorber at a temperature at or below 35° C.

In accordance with still another aspect, a method of capturing carbon dioxide from a flue gas, comprises, consists of or consists essentially of: (a) controlling, by a controller-controlled cooling system, a current temperature of a carbon dioxide-lean carbon capture solution being delivered to different levels of an absorber through a plurality of lean carbon capture solution inlets, (b) controlling, by the controller-controlled cooling system, a current temperature of a flue gas being delivered to a flue gas inlet of the absorber and (c) maintaining a desired temperature profile at the different levels of the absorber to enhance carbon dioxide loading in the rich solvent from the flue gas to a carbon capture solution and reduce energy requirements for lean carbon capture solution regeneration in a stripper.

Still further, the method may include controlling, by a controller-controlled cooling system a current temperature of a portion of a carbon dioxide-rich carbon capture solution being recycled to a bottom section of the absorber. The method may also include the steps of capturing the carbon dioxide with a carbon dioxide-lean carbon capture solution in the absorber to generate a carbon dioxide-rich carbon capture solution, regenerating the carbon dioxide-lean carbon capture solution from the carbon dioxide-rich carbon capture solution in the stripper, and maintaining the carbon dioxide-rich carbon capture solution in a bottom section of the absorber at a temperature at or below 45° C. In some embodiments, the method may include maintaining the carbon dioxide-rich carbon capture solution in a bottom section of the absorber at a temperature at or below 35° C.

In at least one embodiment, the method further includes monitoring, by a plurality of temperature sensors, a current temperature of the carbon capture solution at each level of the absorber. The method may include providing a controller-controlled chiller upstream from each of the plurality of lean carbon capture solution inlets to allow for independent temperature control of the carbon dioxide-lean carbon capture solution being delivered to each of the levels of the absorber. The method may include cooling the flue gas upstream from the absorber using a direct contact cooler.

In the following description, there are shown and described several different embodiments of the new and improved carbon capture system and the related method of capturing carbon dioxide from a flue gas stream. As it should be realized, the system and method are capable of other, different embodiments and their several details are capable of modification in various, obvious aspects all without departing from the device as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein by reference and forming a part of the specification, illustrate several aspects of the new and improved carbon capture system and the related method of capturing carbon dioxide from a flue gas stream and together with the description serve to explain certain principles thereof.

FIG. 1 is a schematic representation of a conventional carbon dioxide absorber system.

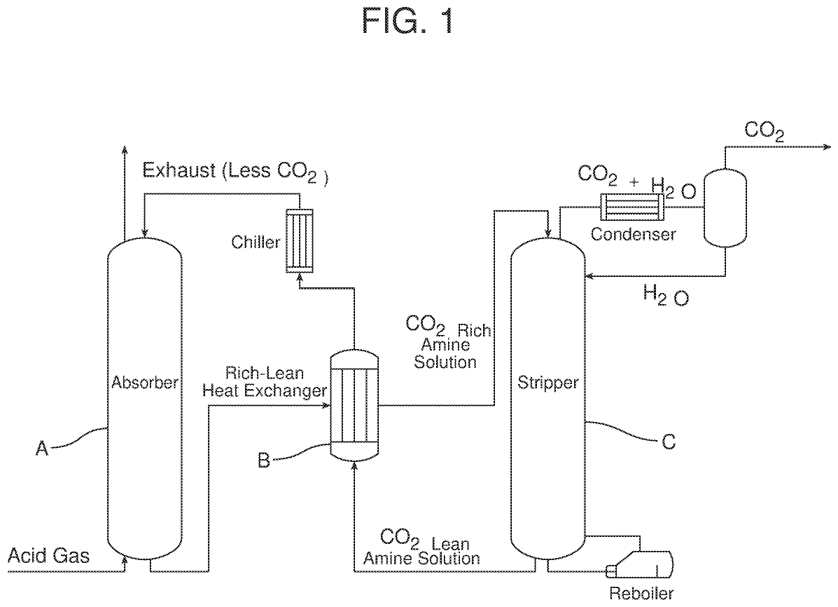

FIG. 2A is a schematic representation of the new and improved carbon capture system that is the subject matter of this document.

FIG. 2B is a schematic representation of an alternative embodiment of the carbon capture system.

FIG. 3 is a graph of absorber temperature profile for aqueous amine solvent (L/G=2.5) at different inlet temperatures. Flue gas temperature not reduced (˜14 vol % CO₂).

FIG. 4 is a graph of absorber temperature profile for aqueous amine solvent (L/G=0.88-1.1) at different inlet lean temperatures using low wet bulb temperature simulated NGCC flue gas (˜4 vol % CO₂).

FIG. 5 is a graph of absorber temperature profile for water-lean solvent at different L/G and inlet lean temperatures (˜14 vol % inlet CO₂ concentration).

FIG. 6 is a graph of absorber temperature profile for water-lean solvent at different inlet L/G and inlet lean temperatures with lowering of flue gas wet bulb temperature (˜4 vol % inlet CO₂ concentration).

FIG. 7 is a graph comparing rich carbon loadings and stripper dT for experiments with and without absorber flue gas inlet cooling.

Reference will now be made in detail to the present preferred embodiments of the device.

### DETAILED DESCRIPTION

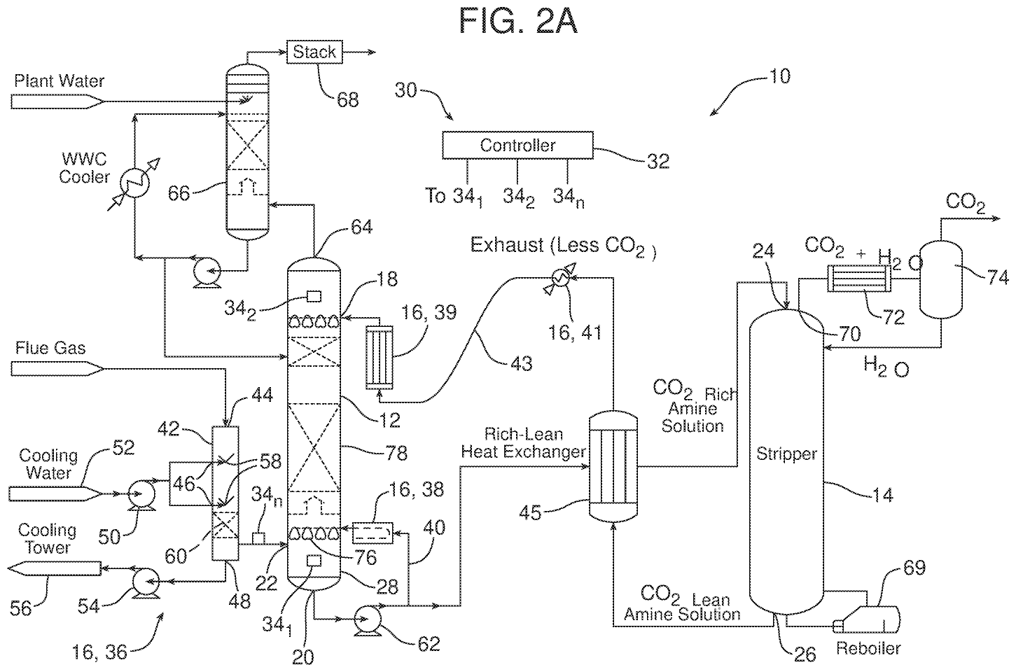

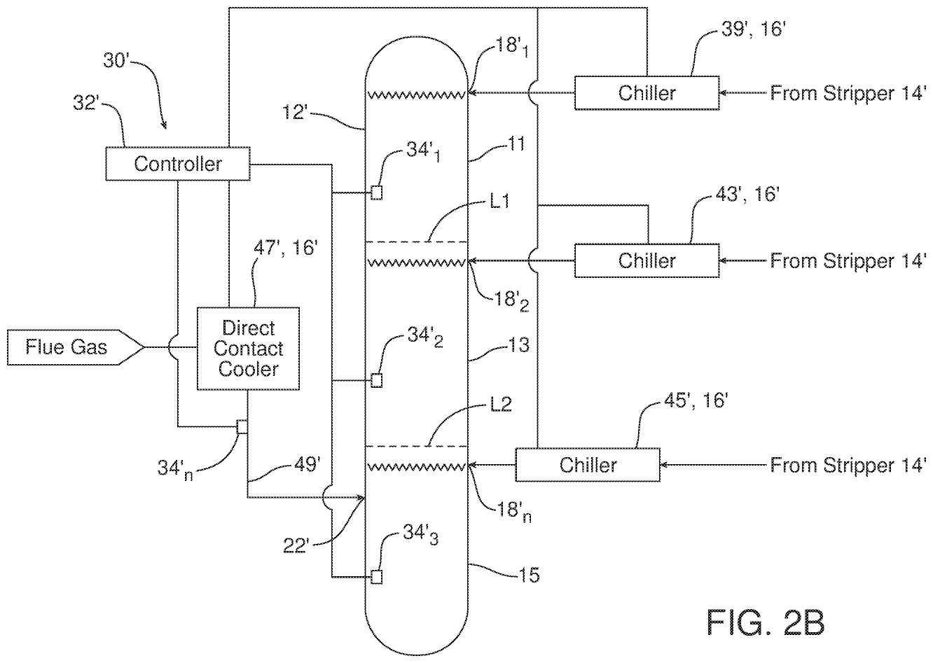

Reference is now made to FIG. 2A which is a schematic illustration of one possible embodiment of the new and improved carbon capture system 10 adapted to enhance rich carbon loading of a carbon capture solution and thereby minimize specific reboiler duty during regeneration in the stripper when applied to flue gas stream with CO₂ concentration less than 10 vol % such as natural gas combine cycle (NGCC) or other point source flue gas such as natural gas boiler, steel/aluminum, and food processing. As is known in the art, the carbon capture solution may comprise an amine solution/solvent of, for example, primary amines such as monoethanolamine (MEA), secondary amines such as piperazine (PZ), tertiary amines such as methyldiethanolamine (MDEA) or combinations thereof.

As illustrated, the carbon capture system 10, configured for thermal swing absorption processing, includes an absorber 12, a stripper 14 and a cooling system, generally designated by reference numeral 16. The carbon capture solution is circulated in a loop between the absorber 12 and the stripper 14 in a manner described in greater detail below.

The absorber 12 includes a lean carbon capture solution inlet 18 at the top section of the absorber, a rich carbon capture solution outlet 20 at the bottom of the absorber and a flue gas inlet 22. The stripper 14 includes a rich carbon capture solution inlet 24 and a lean carbon capture solution outlet 26. The rich carbon capture solution inlet 24 is connected to the rich carbon capture solution outlet 20 to allow carbon dioxide-rich carbon capture solution to be delivered from the absorber 12 to the stripper 14 and the lean carbon capture solution outlet 26 is connected to the lean carbon capture solution inlet 18 to allow carbon dioxide-lean carbon capture solution to be delivered from the stripper to the absorber as set forth with greater detail below.

The cooling system 16 is adapted to cool at least one of (a) the flue gas upstream from the flue gas inlet 22 and (b) the portion of the carbon dioxide-rich carbon capture solution being recycled to a bottom section 28 of the absorber 12. The bottom section 28 generally refers to the portion of the absorber including the flue gas inlet 22. In at least some embodiments, the bottom section 28 refers to the lowermost 20% to 50% of the absorber 12.

The carbon capture system 10 also includes a control module 30. As illustrated in FIG. 2, the control module 30 includes a controller 32 and a plurality of temperature sensors 34₁-34ₙ. In the illustrated embodiment, the temperature sensor 34₁ is adapted to sense a temperature of the carbon dioxide-rich carbon capture solution at the bottom section 28 of the absorber 12. The temperature sensor 34₂ is adapted to sense the temperature of the carbon dioxide-lean carbon capture solution at the top section of the absorber 12. The temperature sensor 34ₙ is adapted to sense the temperature of the flue gas being delivered to the absorber through the flue gas inlet 22. The controller 32 is adapted to control the temperature profile of the carbon capture solution in the absorber 12 and maintain the carbon dioxide-rich carbon capture solution in the bottom section 28 of the absorber 12 at a predetermined temperature. In many embodiments, that predetermined temperature is less than or equal to 45° C. In still other embodiments, that predetermined temperature is less than or equal to 35° C. This is accomplished by controlling the input temperatures of (a) the carbon dioxide-lean carbon capture solution at the input 18, (b) the portion of the carbon dioxide-rich carbon capture solution at the input 19 and the flue gas at the input 22.

In the illustrated embodiment, the cooling system 16 comprises (a) a direct contact cooler 36 upstream from the flue gas inlet 22 (b) a chiller 38 in a carbon dioxide-rich carbon capture solution recycling circuit 40 adapted for recycling a portion of the carbon dioxide-rich carbon capture solution to the bottom section 28 of the absorber 12 and (c) the chiller 39 and/or heat exchanger 41 in the lean carbon capture line 43 for delivering carbon dioxide-lean carbon capture solution from the stripper 14 to the absorber 12. The addition of the chiller 39 further lowers the temperature of the lean carbon capture solution, being fed to the absorber 12, to the point that it is below that accomplished by just exchanging heat with the lean carbon capture solution at the heat exchanger 45 and even lower than what can typically be accomplished with cooling water.

As shown in FIG. 2A, the direct contact cooler 36 includes a cooling chamber 42 having a flue gas inlet 44, a cooling water inlet 46 (two shown) and a water recycling outlet 48. The direct contact cooler 36 also includes a cooling water pump 50, connected to a cooling water source 52, and a recycling pump 54 adapted for returning water through a cooling tower 56 to the cooling water source 52. Still further, the direct contact cooler 36 includes at least one cooling water sprayer 58 (two shown) in the cooling chamber 42 that receives cooling water from the cooling water pump 50 and sprays that water in a fine mist to efficiently cool the flue gas with which it is in contact. Structured packing 60 may be provided in the cooling chamber 42 to increase the cooling efficiency of the direct contact cooler 36.

The chiller 38 in the carbon dioxide-rich carbon capture solution recycling circuit 40 may be of substantially any type of chiller known in the art and suited or adapted for cooling the portion of the carbon dioxide-rich carbon capture solution being recycled to the bottom section 28 of the absorber 12. That portion may comprise, for example, between about 10 and about 30 percent of the entire amount of carbon dioxide-rich carbon capture solution being pumped by the pump 62 from the bottom of the absorber 12, depending on the size of the chiller 38. The chiller 39 and heat exchanger 41 for cooling the lean carbon capture solution may be of any type known in the art to be useful for the intended purpose.

The carbon dioxide-depleted, treated flue gas, is discharged from the absorber 12 at the treated flue gas outlet 64 and passed through a water wash vessel 66 in order to capture any residual carbon capture solution that may remain. That treated flue gas is then discharged back into the atmosphere from the stack 68.

As is known in the art, the stripper 14 includes a reboiler 69 that is operated to maintain a desired operating temperature in the stripper to provide for more efficient and effective recovery of the carbon dioxide from the carbon dioxide-rich carbon capture solution and regeneration of the carbon dioxide-lean carbon capture solution that is then recycled to the absorber 12. The captured carbon dioxide that is released from the carbon dioxide-rich carbon capture solution is discharged from the carbon dioxide outlet 70 at the top of the stripper 14 and then passed through the condenser 72 to condense any residual water vapor. That water vapor is returned to the stripper 14 by the gas/liquid separator 74 while the carbon dioxide is routed for sequestration or other purposes.

Reference is now made to FIG. 2B which illustrates an alternative embodiment of the carbon capture system 10′. The absorber 12′ of this system 10′ includes three levels: (a) an upper section 11 above the phantom line L1, (b) an intermediate section 13 between phantom lines L1 and L2, and (c) a lower section 15 below the phantom line L2. The cooling system 16′ includes the chillers 39′,43′, 45′ and the direct contact cooler 47′.

A portion of the carbon dioxide-lean carbon capture solvent is delivered from the lean carbon capture solvent outlet of the stripper 14′ to (a) the lean carbon capture solution inlet 181′ at the upper section 11 of the absorber 12′ through the chiller 39′, (b) the lean carbon capture solution inlet 182′ at the intermediate section 13 of the absorber through the chiller 43′, and (c) the lean carbon capture solution inlet 18. at the lower section 15 of the absorber through the chiller 45′. Flue gas is delivered to the absorber 12′ at the flue gas inlet 22′ after passing through the direct contact cooler 47′.

The control module 30′ includes a controller 32′ connected to (a) a first temperature sensor 34₁′ in the upper section 11 of the absorber 12, (b) a second temperature sensor 34₂′ in the intermediate section 13 of the absorber 12, (c) a third temperature sensor 34₃′ in the lower section 15 of the absorber 12, and (d) a fourth temperature sensor 34ₙ′ in the flue gas line 49′ between the direct contact cooler 47′ and the flue gas inlet 22′.

The controller 32′, in response to the temperature data received from the temperature sensors 34₁′-34ₙ′, independently controls operation of: (a) the chiller 39′ to continuously control the current temperature of the lean carbon capture solvent to be sprayed in the upper section 11 of the absorber 12′ at the spray nozzles 51′, (b) the chiller 43′ to continuously control the temperature of the lean carbon capture solvent to be sprayed in the intermediate section 13 of the absorber at the spray nozzles 53′, (c) the chiller 45′ to continuously control the temperature of the lean carbon capture solvent to be sprayed in the lower section 15 of the absorber at the spray nozzles 55′, and (d) the direct contact cooler 47′ to continuously control the temperature of the flue gas delivered to the absorber at the flue gas inlet 22′. Advantageously, the independent control set forth above allows the controller 32′ to effectively control the temperature profile of the carbon capture solvent at each level or section of the absorber 12′.

As a result of this control, the carbon capture system 10′ effectively maintains a desired temperature profile at the different levels 11, 13, 15 of the absorber 12′ to enhance rich loading of carbon dioxide from the flue gas to a carbon capture solution and reduce energy requirements for lean carbon capture solution regeneration in the stripper. This control includes maintaining the carbon dioxide-rich carbon capture solution in a bottom section or lower section 15 of the absorber 12′ at a temperature at or below 45° C., or in some embodiments, at or below 35° C. thereby allowing one to optimize the performance of the carbon capture system 10′ depending upon the type of carbon capture solution being circulated through the absorber 12′ and stripper 14′.

The carbon capture systems 10, 10′ shown in FIGS. 2A and 2B and described above are useful in a new and improved method of capturing carbon dioxide from a flue gas. As generally shown in FIGS. 2A and 2B and outlined above, that method includes the steps of: (a) controlling, by a controller-controlled cooling system 16, 16′, a current temperature of a carbon dioxide-lean carbon capture solution being delivered to different levels of an absorber 12, 12′ through a plurality of lean carbon capture solution inlets 18₁-18ₙ or 18₁′-18ₙ′, (b) controlling, by the controller-controlled cooling system, a current temperature of a flue gas being delivered to a flue gas inlet 22, 22′ of the absorber; and maintaining a desired temperature profile at the different levels 11, 13, 15 of the absorber to enhance rich loading of carbon dioxide from the flue gas to a carbon capture solution and reduce energy requirements for lean carbon capture solution regeneration in the stripper 14, 14′.

The method may include controlling, by the controller-controlled cooling system 16, 16′ a current temperature of a portion of a carbon dioxide-rich carbon capture solution being recycled to a bottom section 15, 28 of the absorber 12, 12′. Still further, the method may include (a) capturing the carbon dioxide with a carbon dioxide-lean carbon capture solution in the absorber 12, 12′ to generate a carbon dioxide-rich carbon capture solution, (b) regenerating the carbon dioxide-lean carbon capture solution from the carbon dioxide-rich carbon capture solution in the stripper 14, 14′, and (c) maintaining the carbon dioxide-rich carbon capture solution in a bottom section 15, 28 of the absorber at a temperature at or below 45° C. Alternatively, the method may include maintaining the carbon dioxide-rich carbon capture solution in a bottom section 15, 18 of the absorber 12, 12′ at a temperature at or below 35° C.

As described above and clearly illustrated in the drawing FIGS. 2A and 2B, the method includes monitoring, by a plurality of temperature sensors 34₁-34ₙ or 34₁′-34ₙ′, a current temperature of the carbon capture solution at each level 11, 13, 15 of the absorber 12, 12′.

The method also includes providing a controller-controlled chiller 38, 39, 41 or 39′, 43′, 45′ upstream from each of the plurality of lean carbon capture solution inlets 18₁-18ₙ or 18₁′-18ₙ′ to allow for independent temperature control of the carbon dioxide-lean carbon capture solution being delivered to each of the levels 11, 13, 15 of the absorber 12, 12′. The method may also include cooling the flue gas upstream from the absorber 12, 12′ using a direct contact cooler 36, 47.

The systems 10 and 10′ and method described above provide a number of benefits and advantages over state of the art carbon capture systems and methods. The system 10 and method involve controlling the temperature profile of the carbon capture solution in the absorber 12, 12′ by controlling both the carbon dioxide-lean carbon capture solution and flue gas feed stream temperatures at the inlets 18, 18₁′-18ₙ′, 22, 22′ and optionally cooling of the portion of the carbon dioxide-rich carbon capture solution being recycled to the bottom section 28 of the absorber through the recycling circuit 40. In the chiller 38, chilled water may be used to cool the carbon dioxide-rich carbon capture solution, which is then sprayed through spray heads 76 over the flue gas entering the absorber through the inlet 22, to remove additional moisture, lowering the wet bulb temperature to less than 30° C. prior to feeding it to the bottom of the absorber packed section 78.

In contrast, in the conventional process, flue gas is cooled in a direct contact cooler to −43° C. The absorber temperature profile is generally controlled through the solvent and gas feed stream temperatures and intercooling of the solvent in the lower section of the absorber to enhance the driving force for CO₂ absorption. Typical absorber bottom temperatures of amine-based solvent for coal-based flue gas in the conventional process is ˜45-55° C. The additional lowering of inlet flue gas wet bulb temperature resulting from the technology described in this document promotes additional heat exchange between the flue gas and the carbon capture solution beyond what is achieved with the conventional absorber configuration.

The reduction in temperature in the bottom section 28 of the absorber 12 enhances CO₂ absorption because of a larger difference between the gas phase CO₂ partial pressure and equilibrium partial pressure of CO₂ resulting from the loading in the carbon capture solution. This leads to an increase in the rich carbon loading of the carbon capture solution at the absorber bottom 28 and the increased carbon loading of the carbon capture solution fed to the stripper 14, lowers the amount of water vaporized during carbon dioxide-lean carbon capture solution regeneration resulting in significant energy savings from the lower steam requirements with the technology. Because the energy consumption to regenerate carbon dioxide-lean carbon capture solution for the process is significantly reduced from the lower specific reboiler duty, the overall plant efficiency is improved.

### Experimental

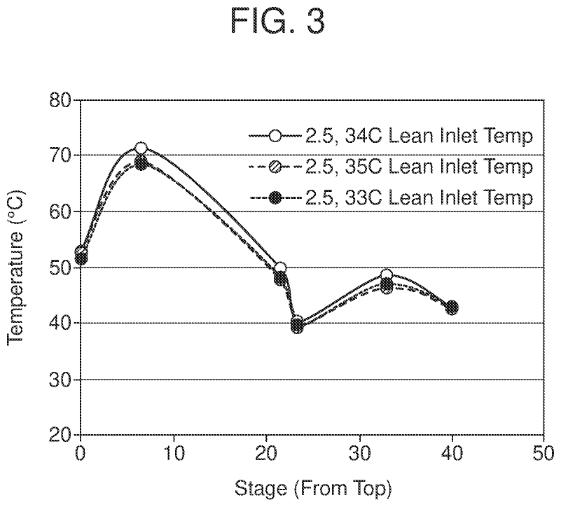

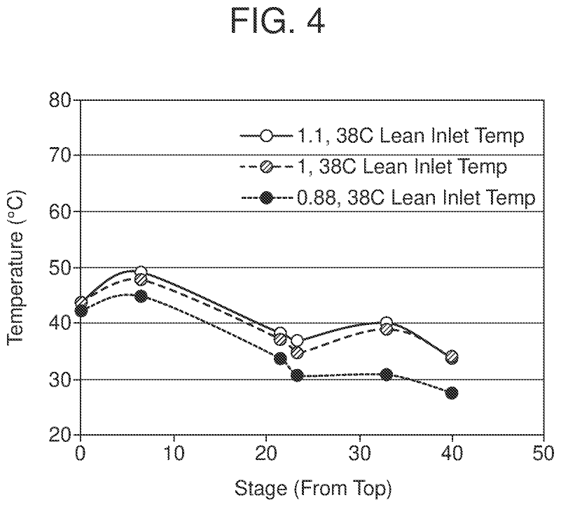

Lower Absorber Bottom Temperature: Typical absorber temperature profiles for an aqueous amine solvent/carbon capture solution used in the UK 0.7 MWe CO₂ capture unit for CO₂ absorption from flue gas from a coal fired power plant are shown in FIG. 3 for tests where the wet bulb temperature of the flue gas was not lowered and FIG. 4 where wet bulb temperature of the flue gas was lowered using the system and method described in this document. The absorber column is 32″ diameter with two packed sections of total height 40′ with an intercooler between the packed sections to enhance CO₂ absorption in the lower section of the absorber. In FIG. 3, where the wet bulb temperature of the flue gas was not lowered, the exothermic reaction between the higher concentration CO₂ (˜14 vol % dry basis) feed to the bottom of absorber and the higher countercurrent flowing solvent results in more heat release which accounts for the higher temperature bulge (˜70° C.) in the top section of the absorber. The temperature progressively decreased and increased slightly after intercooling from the enhanced absorption before it decreased to ˜43° C. at the bottom of the absorber. A similar behavior is observed for the temperature profile shown in FIG. 4, but here a lower temperature bulge of ˜50° C. as well as lowered absorber bottom temperatures (˜28-34° C.) are obtained.

The lower wet bulb temperature flue gas with concentration CO₂ (˜4 vol % dry basis) fed to the absorber results in lower heat release on reacting with the solvent flowing at the reduced L/G ratio, accounting for the observed smaller bulge temperature.

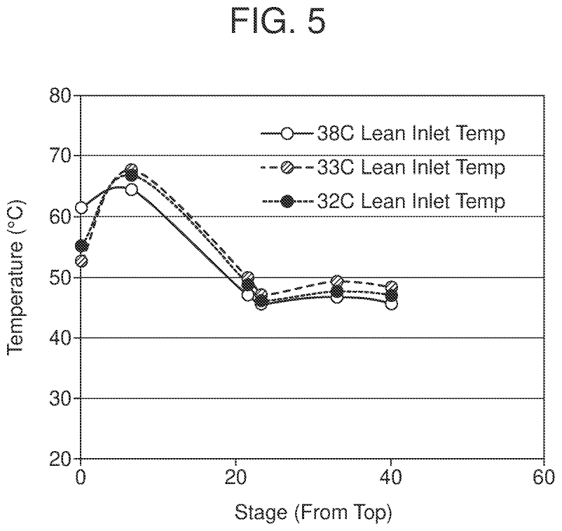

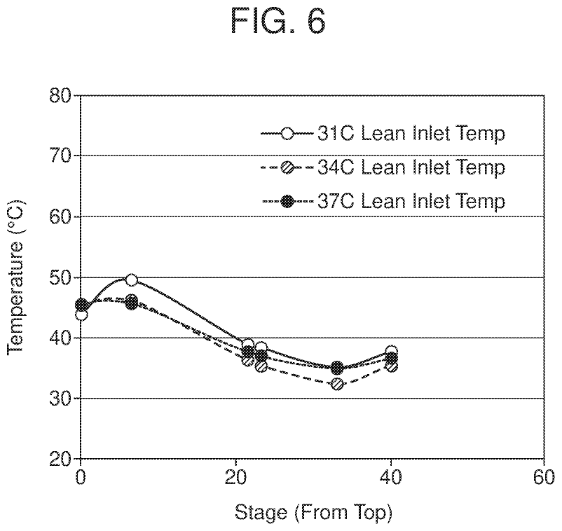

The lowering of the absorber bottom temperature demonstrated with the aqueous amine solvent/carbon capture solution was similarly observed in experiments performed with a water-lean solvent with an inlet concentration of ˜4 vol % and a wet bulb temperature at ˜25° C. A comparison of the temperature profiles for the water lean solvent for flue gas with wet bulb temperature of ˜40° C. (FIG. 5) and with ˜25° C. (FIG. 6) also show a reduction of close to 10° C. in the absorber bottom temperature. The effect is therefore applicable to a wide array of solvents; aqueous and non-aqueous, or water-lean solvents, used in the CO₂ capture process.

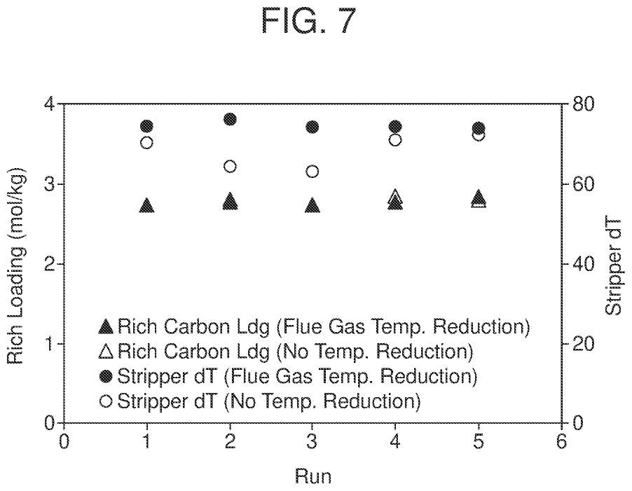

Similar rich loadings are obtained for experiments with the flue gas feed to the absorber with a lower CO₂ concentration and a lower wet bulb temperature as the flue gas with higher inlet CO₂ concentration and higher wet bulb temperature, as shown in FIG. 7. The similar rich loading, and the higher temperature difference between the stripper bottom and overhead temperature (stripper dT), also shown in FIG. 7, provided regeneration conditions that resulted in a specific reboiler heat duty reduction of over 20%.

Each of the following terms written in singular grammatical form: “a”, “an”, and “the”, as used herein, means “at least one”, or “one or more”. Use of the phrase “One or more” herein does not alter this intended meaning of “a”, “an”, or “the”. Accordingly, the terms “a”, “an”, and “the”, as used herein, may also refer to, and encompass, a plurality of the stated entity or object, unless otherwise specifically defined or stated herein, or, unless the context clearly dictates otherwise. For example, the phrase: “a carbon capture solution”, as used herein, may also refer to, and encompass, a plurality of carbon capture solutions.

Each of the following terms: “includes”, “including”, “has”, “having”, “comprises”, and “comprising”, and, their linguistic/grammatical variants, derivatives, or/and conjugates, as used herein, means “including, but not limited to”, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof.

The phrase “consisting of”, as used herein, is closed-ended and excludes any element, step, or ingredient not specifically mentioned. The phrase “consisting essentially of”, as used herein, is a semi-closed term indicating that an item is limited to the components specified and those that do not materially affect the basic and novel characteristic(s) of what is specified.

Terms of approximation, such as the terms about, substantially, approximately, etc., as used herein, refers to ±10% of the stated numerical value.

Although the system 10, 10′ and method of this disclosure have been illustratively described and presented by way of specific exemplary embodiments, and examples thereof, it is evident that many alternatives, modifications, or/and variations, thereof, will be apparent to those skilled in the art. It is intended that all such alternatives, modifications, or/and variations, fall within the spirit of, and are encompassed by, the broad scope of the appended claims.

What is claimed:

1. A carbon capture system, comprising:
an absorber having a plurality of lean carbon capture solution inlets at different levels of the absorber, a rich carbon capture solution outlet, and a flue gas inlet;
a stripper having at least one rich carbon capture solution inlet connected to the rich carbon capture solution outlet and a lean carbon capture solution outlet connected to the plurality of lean carbon capture solution inlets;
a cooling system adapted to independently cool (a) a flue gas upstream from the flue gas inlet and (b) a carbon dioxide-lean carbon capture solution being delivered to each of the plurality of lean carbon capture solution inlets at the different levels of the absorber; and
a control module including a controller and a plurality of temperature sensors wherein the controller is responsive to the plurality of temperature sensors provided at each of the different levels of the absorber to control operation of the cooling system and thereby maintain a desired temperature profile at the different levels of the absorber to enhance loading of carbon dioxide from the flue gas to a carbon capture solution and reduce energy requirements for lean carbon capture solution regeneration in the stripper.

2. The carbon capture system of claim 1, wherein the controller is adapted to maintain a carbon dioxide rich-carbon capture solution in a bottom section of the absorber at a predetermined temperature less than or equal to 45° C.

3. The carbon capture system of claim 1, wherein the controller is adapted to maintain the carbon dioxide rich-carbon capture solution in the bottom section of the absorber at a predetermined temperature less than or equal to 35° C.

4. The carbon capture system of claim 1, wherein the cooling system includes a direct contact cooler upstream from the flue gas inlet that is adapted to cool the flue gas to a predetermined temperature prior to delivery to the flue gas inlet and the control module further includes a flue gas temperature sensor for monitoring current temperature of the flue gas exiting the direct contact cooler.

5. The carbon capture system of claim 4, wherein the direct contact cooler includes (a) a cooling chamber having a flue gas inlet, a cooling water inlet, and a water recycling outlet, (b) a cooling water pump connected to a cooling water source and (c) a recycling pump adapted for returning water to the cooling water source.

6. The carbon capture system of claim 5, wherein the direct contact cooler further includes at least one cooling water sprayer in the cooling chamber that receives cooling water from the cooling water pump.

7. The carbon capture system of claim 1, wherein the cooling system further includes a cooler in a carbon dioxide rich-carbon capture solution recycling circuit adapted for recycling a portion of the carbon dioxide rich-carbon capture solution to the bottom section of the absorber and/or the different levels of absorber packing.

8. The carbon capture solution of claim 1, wherein the cooling system includes a separate and independently controller-controlled chiller upstream from each of the plurality of lean carbon capture solution inlets.

9. A method of capturing carbon dioxide from a flue gas, comprising:
capturing the carbon dioxide with a carbon dioxide-lean carbon capture solution in an absorber to generate a carbon dioxide-rich carbon capture solution;
regenerating the carbon dioxide-lean carbon capture solution from the carbon dioxide-rich carbon capture solution in a stripper; and
maintaining the carbon dioxide-rich carbon capture solution in a bottom section of the absorber at a temperature at or below 45° C.

10. The method of claim 9, including maintaining the carbon dioxide-rich carbon capture solution in a bottom section of the absorber at a temperature at or below 35° C.

11. A method of capturing carbon dioxide from a flue gas, comprising:
controlling, by a controller-controlled cooling system, a current temperature of a carbon dioxide-lean carbon capture solution being delivered to different levels of an absorber through a plurality of lean carbon capture solution inlets;
controlling, by the controller-controlled cooling system, a current temperature of a flue gas being delivered to a flue gas inlet of the absorber; and
maintaining a desired temperature profile at the different levels of the absorber to enhance rich loading of carbon dioxide from the flue gas to a carbon capture solution and reduce energy requirements for lean carbon capture solution regeneration in a stripper.

12. The method of claim 11, including controlling, by a controller-controlled cooling system a current temperature of a portion of a carbon dioxide-rich carbon capture solution being recycled to a bottom section of the absorber and/or the different levels of absorber packing.

13. The method of claim 12, including:
capturing the carbon dioxide with a carbon dioxide-lean carbon capture solution in the absorber to generate a carbon dioxide-rich carbon capture solution;
regenerating the carbon dioxide-lean carbon capture solution from the carbon dioxide-rich carbon capture solution in the stripper; and
maintaining the carbon dioxide-rich carbon capture solution in a bottom section of the absorber at a temperature at or below 45° C.

14. The method of claim 13, including maintaining the carbon dioxide-rich carbon capture solution in a bottom section of the absorber at a temperature at or below 35° C.

15. The method of claim 12, further including monitoring, by a plurality of temperature sensors, a current temperature of the carbon capture solution at each level of the absorber.

16. The method of claim 15, further including providing a controller-controlled chiller upstream from each of the plurality of lean carbon capture solution inlets to allow for independent temperature control of the carbon dioxide-lean carbon capture solution being delivered to each of the levels of the absorber.

17. The method of claim 12, further including cooling the flue gas upstream from the absorber using a direct contact cooler.

18. The method of claim 11, including:
capturing the carbon dioxide with a carbon dioxide-lean carbon capture solution in the absorber to generate a carbon dioxide-rich carbon capture solution;
regenerating the carbon dioxide-lean carbon capture solution from the carbon dioxide-rich carbon capture solution in a stripper; and
maintaining the carbon dioxide-rich carbon capture solution in a bottom section of the absorber at a temperature at or below 45° C.

19. The method of claim 18, including maintaining the carbon dioxide-rich carbon capture solution in a bottom section of the absorber at a temperature at or below 35° C.

20. The method of claim 11, further including providing a controller-controlled chiller upstream from each of the plurality of lean carbon capture solution inlets to allow for independent temperature control of the carbon dioxide-lean carbon capture solution being delivered to each of the levels of the absorber.
